(19) United States
(12) Patent Application Publication
(10) Pub. No.: US 2014/0261847 A1
(43) Pub. Date: Sep. 18, 2014

(54) COMPOSITE MANDREL FOR AN ISOLATION TOOL

(71) Applicant: Sara Molina, Midland, TX (US)

(72) Inventor: Sara Molina, Midland, TX (US)

(21) Appl. No.: 13/827,877

(22) Filed: Mar. 14, 2013

(51) Int. Cl. F16L 9/12; B29C 70/54; B29C 70/30

(52) U.S. Cl. CPC F16L 9/12; B29C 70/30; B29C 70/545
USPC 138/145; 264/162

(57) ABSTRACT

A mandrel for an isolation tool for completion of oil and gas wells and a method for making the mandrel is disclosed. The mandrel comprising a composite tube, wherein the composite tube has an inner diameter; wherein a first section of the composite tube has a first outer diameter and a second section has a second outer diameter, wherein the first end has a beveled surface defined by a first angle with an interior surface of the composite tube, wherein the composite tube is made from a plurality of layers of fibers coated with a chemical matrix. The method comprises interweaving a plurality of layers of fibers around a core, coating the plurality of layers of fibers with a chemical matrix to form a composite tube, curing the composite tube, milling or grinding the outer surface of the composite tube to form a mandrel, and removing the core.

### PRIOR RELATED APPLICATIONS

Not Applicable (“N/A”)

### FEDERALLY SPONSORED RESEARCH STATEMENT

N/A

### REFERENCE TO MICROFICHE APPENDIX

N/A

### FIELD OF INVENTION

The invention relates generally to composite isolation tools for completion of oil and gas wells, and, in particular, to an improved composite mandrel for an isolation tool and a method for making the composite mandrel.

### BACKGROUND OF THE INVENTION

Downhole isolation tools include composite bridge plugs and frac plugs that are used in completion and fracing of oil and gas wells. The composite bridge plug can be used to temporarily isolate a lower section of a wellbore while an upper section is being tested or cemented or to permanently seal a lower section of a wellbore from production. After the section has been tested or cemented, the composite bridge plug can be drilled out and circulated to the surface.

The frac plug is used to isolate one or more production zones during high pressure stimulation fracing operations. The frac plug temporarily isolates a section of a wellbore or provides isolation from above or below the insolation point. An operator can pressure up against the frac plug to achieve isolation and to frac the zone. After the zone has been fraced, the frac plug can be drilled and circulated to the surface.

Traditionally, the main body of the composite bridge plug or a frac plug (i.e., a mandrel assembly) is a two-part piece that forms a shoulder or a junction where the two tubes' outside diameters meet. The smaller outside diameter piece (i.e., mandrel) normally fits into the larger inside diameter piece of the larger piece (i.e., muleshoe), similar to a nut. The mandrel assembly is held together with a connection comprising threads and adhesives/bonding agents, and often fails, resulting in a complete failure of the plug. Due to the failures, the mandrel assembly has been designed with different thread connections, adhesive agents/bonding agents and composite materials, and used with limited success.

Therefore, there is the need for an improved mandrel assembly for composite bridge plugs and frac plugs that does not fail during operations.

### SUMMARY OF THE INVENTION

The invention relates generally to composite isolation tools for completion of oil and gas wells and for fracing production zones of those wells, and, in particular, to an improved composite mandrel for isolation tools and a method for making the composite mandrel.

In an embodiment, a mandrel for an isolation tool comprises a composite tube having a first end and a second end, wherein the composite tube has an inner diameter extending from the first end to the second end, wherein a first section of the composite tube has a first outer diameter such that the composite tube in the first section has a first thickness and a second section of the composite tube has a second outer diameter such that the composite tube has a second thickness, wherein the first end has a beveled surface defined by a first angle with an interior surface of the composite tube, wherein the composite tube is made from a plurality of layers of fibers coated with a chemical matrix; wherein a second layer of fibers overlaps a first layer of fibers with a first angle of fabrication from about 40 to about 85 degrees, and wherein a third layer of fibers overlaps the second layer of fibers with a second angle of fabrication from about 40 to about 85 degrees.

In an embodiment, a method of making the mandrel of claim 1 comprising the steps of: interweaving a plurality of layers of fibers around a removable core, wherein a second layer of fibers overlaps a first layer of fibers with a first angle of fabrication from about 40 to about 85 degrees and wherein a third layer of fibers overlaps the second layer of fibers with a second angle of fabrication, coating the plurality of layers of fibers with a chemical matrix to form a composite tube, curing the composite tube at ambient temperature by reacting the chemical matrix with itself in the presence of a catalyst or by reacting the chemical matrix with a hardener in the presence of heat, grinding the outer surface of the composite tube to form a mandrel, wherein a first section of the composite tube has a first outer diameter and a second section of the composite tube has a second outer diameter, and removing the removable core.

These and other objects, features, and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

For a further understanding of the nature and objects of the present invention, reference should be made to the following detailed disclosure, taken in conjunction with the accompanying drawings, in which like parts are given like reference numerals, and wherein:

FIG. 1 shows a mandrel for an isolation tool according to an embodiment of the present invention;

FIG. 2 shows a bridge plug assembly according to an embodiment of the present invention;

FIG. 3 shows an isolation tool assembly according to an embodiment of the present invention;

FIG. 4 shows a flow diagram for a method of making a mandrel for an isolation tool according to an embodiment of the present invention;

FIG. 5 shows a photograph of interweaving a plurality of fibers to form a composite tube according to an embodiment of the present invention; and

FIG. 6 shows a photograph of grinding an outer surface of a composite tube according to an embodiment of the present invention.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

A composite mandrel assembly 100 for an isolation tool according to the present invention is shown in FIG. 1. The mandrel assembly 100 comprises a composite tube 102 having a first end 104 and a second end 106. The composite tube 102 has an inner diameter 108 extending from the first end 104 to the second end 106. In an embodiment, the inner diameter 108 is from about 0.3 inches to about 12 inches, more preferably, from about 0.3 inches to about 6 inches and, most preferably, from about 0.3 inches to about 3 inches.

A first section 110 of the composite tube 102 has a first outer diameter 112 such that the composite tube 102 in the first section 110 has a first thickness 114 and a second section 116 of the composite tube 102 has a second outer diameter 118 such that the composite tube 102 has a second thickness 120. If the first outer diameter 112 and second outer diameter 118 are different, a shoulder 122 will be formed between the first section 110 and second section 116. In an embodiment, the first outer diameter 112 is from about 0.5 inch to about 12 inches, more preferably, from about 0.5 inch to about 10 inches, and, most preferably, from about 0.5 inch to about 8 inches. In an embodiment, the second outer diameter 118 is from about 0.5 inch to about 12 inches, more preferably, from about 0.5 inch to about 10 inches, and, most preferably, from about 0.5 inch to about 8 inches. In an embodiment, the first outer diameter 112 may be different from the second outer diameter 118. In an embodiment, the first outer diameter 112 may be identical to the second outer diameter 118.

In an embodiment, the first thickness 114 is from about 0.3 inch to about 4 inches, more preferably, from about 0.3 inch to about 4 inches, and, most preferably, from about 0.3 inch to about 3 inches. In an embodiment, the second thickness 120 is from about 0.3 inch to about 5 inches, preferably, from about 0.3 inch to about 4 inches, and, most preferably, from about 0.3 inch to about 3 inches.

In an embodiment, the first end 104 of the composite tube has a beveled surface 124 defined by a first angle 126 with an interior surface 128 of the composite tube 102. In an embodiment the first angle 126 is from about 40 to about 80 degrees, preferably from about 50 to 70 degrees, even more preferably from about 55 to about 65 degrees, and most preferably from about 58 to about 62 degrees.

In an embodiment, the second end 106 has a tapered end 130 defined by a second angle 132 with an exterior surface 134 of the composite tube 102. In an embodiment, the second angle 132 is from about 40 to about 80 degrees, preferably from about 50 to 70 degrees, even more preferably from about 55 to about 65 degrees, and, most preferably from about 60 to about 63 degrees.

In an embodiment, the composite tube 102 may from about six (6) inches to about thirty-six (36) inches long. For example, for a twenty-four (24) inch composite tube 102, the shorter side of the second section may be from about one half (0.5) to about four and one half (4.5) inches long, and the longer side of the second section may be about five (5) inches long.

In an embodiment, the composite tube 102 is made from layers of fibers coated with a chemical matrix. In an embodiment, a second layer of fiber overlaps a first layer of fiber with an angle of fabrication from about 40 to about 85 degrees, and, more preferably, from about 45 to about 82 degrees. In an embodiment, the composite tube 102 is made from up to 60 layers of fibers with varying angles of fabrication from about 40 to about 85 degrees, and more preferably, from about 45 to about 82 degrees. In an embodiment, the composite tube 102 may be reinforced with one or more layers of fiberglass sheet mat.

In an embodiment, the fibers are selected from the group consisting of fiberglass, carbon, Kevlar, basalt and mixtures thereof. In an embodiment, the fiber is selected from the group consisting of E-glass (e.g., E-glass, 250 yield), S-glass, CR-glass and mixtures thereof. In an embodiment, fiberglass sheet mat may be used separately to reinforce the composite tube 102. Suitable fiberglass fibers and fiberglass sheet mat is available from Owens Corning.

In an embodiment, the chemical matrix is selected from the group consisting of epoxy resins, polyester resins, vinyl ester resins and mixtures thereof. In an embodiment, the epoxy resins are selected from the group consisting of aliphatic epoxy resins (e.g., cycloaliphatic epoxy resin, glycidyl epoxy resin), glycidylamine epoxy resins, phenolic epoxy resins (e.g., novolac epoxy resin, phenolic, Bisphenol A epoxy resin (e.g., Araldite GY 6010 Bisphenol A epoxy resin), Bisphenol F epoxy resin) and mixtures thereto. Suitable epoxy resins are available from Huntsman.

In an embodiment, the chemical matrix may be cured by homopolymerization (i.e., reacting a chemical matrix with itself in the presence of a catalyst) or by copolymerization (i.e. reacting a chemical matrix with a polyfunctional curative or hardener). Suitable catalysts include an anionic catalyst (i.e., a Lewis base, such as tertiary amines, imidazoles) or a cationic catalyst (i.e., Lewis acid, such as a boron trifluride complex). Suitable hardeners include amines (e.g., Aradur 5200 amine hardener), acids, acid anhydrides, phenols, alcohols and thiols. In an embodiment, the chemical matrix:hardener ratio is from about 1:0.20 to about 1:0.28, and more preferably, from about 1:0.22 to about 1:0.26.

In an embodiment, the chemical matrix curing reaction may be accelerated by addition of small quantities of an accelerator. Suitable accelerators include tertiary amines, carboxylic acids and alcohols (especially phenols). For example, Bisphenol A is widely used as an accelerator for epoxy resins.

In an embodiment, one or more other additives such as tougheners, fillers and/or pigments may be added to the chemical matrix. A suitable toughener (e.g., DuoMod) is available from Composites One; a suitable filler (e.g., silica) is available from Composites One; and a suitable pigment (e.g., black pigment) is available from Composites One. In an embodiment, the pigment is from about 0 to about 5 weight percent (wt %) of the total chemical matrix, more preferably, from about 0 to 3 wt %, and most preferably, from about 0 to 2 wt %.

An exemplary bridge plug assembly 200 including a composite mandrel 202 according to the present invention is shown in FIG. 2. The bridge plug assembly 200 comprises a composite mandrel 202 coupled to a bridge plug 204. The illustrated bridge plug assembly 200 shows an element 206, a back-up ring 208, a cone 210, a plurality of cast iron slips 212, a setting ring 214, a support ring 216 and a pin 218 holding a core (not shown) in place, as are customarily present in composite bridge plugs.

An exemplary isolation tool assembly 300 including a composite mandrel 302 according to the present invention is shown in FIG. 3. The isolation tool assembly 300 comprises a composite mandrel 302 coupled to an isolation tool selected from the group consisting of a bridge plug 304 and a frac plug. The illustrated isolation tool assembly 300 shows an element 306, a back-up ring 308, a cone 310, a plurality of cast iron slips 312, a setting ring 314, a support ring 316, a core 318, a pin on adapter 320, a setting sleeve 322, a retaining nut 324 and a tension mandrel 326, as are customarily present in composite isolation tools.

A flow diagram for a method of making 400 a mandrel for an isolation tool according to the present invention is shown in FIG. 4. The method 400 comprises a step 402 of interweaving a layer of fibers around a removable core. In an embodiment, the core may be coated with a release agent. A suitable filament winding machine is available from Magnum Venus Plastech. For example, FIG. 5 illustrates a photograph 500 of the step 402 of interweaving a layer of fibers for making a composite tube 102 according to an embodiment of the present invention. In an embodiment, the fibers are selected from the group consisting of fiberglass, carbon, Kevlar, basalt and mixtures thereof. In an embodiment, the fiber is selected from the group consisting of E-glass (e.g., E-glass, 250 yield), S-glass, CR-glass and mixtures thereof. In an embodiment, fiberglass sheet mat may be used separately to reinforce the composite tube 102. Suitable fiberglass fibers and fiberglass sheet mat is available from Owens Corning.

In an embodiment, a second layer of fibers overlaps a first layer of fibers with an angle of fabrication from about 40 to about 85 degrees and, more preferably from about 45 to about 82 degrees. In an embodiment, a second layer of fibers overlaps a first layer of fibers with a first angle of fabrication from about 40 to about 85 degrees, and, more preferably, from about 45 to about 82 degrees. In an embodiment, a third layer of fibers overlaps the second layer of fibers with a second angle of fabrication from about 40 to about 85 degrees, and, more preferably, from about 45 to about 82 degrees. In an embodiment, the first fabrication angle may be different from the second fabrication angle. In an embodiment, the first and/or second fabrication angles may be different from the third fabrication angle. In an embodiment, the composite tube 102 is made from up to 60 layers of fibers with varying angles of fabrication from about 40 to about 85 degrees, and more preferably, from about 45 to about 82 degrees. In an embodiment, the composite tube 102 may be reinforced with one or more layers of fiberglass sheet mat.

The method 400 further comprises a step 404 of coating a layer of fibers with a chemical matrix to form a composite tube 102. In an embodiment, the chemical matrix is selected from the group consisting of epoxy resins, polyester resins, vinyl ester resins and mixtures thereof. In an embodiment, the epoxy resins is selected from the group consisting of aliphatic epoxy resins (e.g., cycloaliphatic epoxy resin, glycidyl epoxy resin), glycidylamine epoxy resins, phenolic epoxy resins (e.g., novolac epoxy resin, phenolic, Bisphenol A epoxy resin (e.g., Araldite GY 6010 Bisphenol A epoxy resin), Bisphenol F epoxy resin) and mixtures thereto. Suitable epoxy resins are available from Huntsman.

The method 400 further comprises the step 406 of curing the composite tube at ambient temperature by reacting the chemical matrix with itself in the presence of a catalyst or by reacting the chemical matrix with a hardener in the presence of heat to form a mandrel. In an embodiment, the chemical matrix may be cured by homopolymerization (i.e., reacting a chemical matrix with itself in the presence of a catalyst) or by copolymerization (i.e. reacting a chemical matrix with a polyfunctional curative or hardener). Suitable catalysts include an anionic catalyst (i.e., a Lewis base, such as tertiary amines, imidazoles) or a cationic catalyst (i.e., Lewis acid, such as a boron trifluride complex). Suitable hardeners include amines (e.g., Aradur 5200 amine hardener), acids, acid anhydrides, phenols, alcohols and thiols. Relative reactivity (lowest first) is approximately in the order:phenol<anhydride<aromatic amine<cycloaliphatic amine<aliphatic amine<thiol. Suitable catalysts and hardeners are available from Huntsman. In an embodiment, the chemical matrix:hardener ratio is from about 1:0.20 to about 1:0.28, and more preferably, from about 1:0.22 to about 1:0.26.

Although some chemical matrix/hardener combinations will cure at ambient temperature, many combinations require heat to cure. For example, some epoxy resin/hardener combinations require heat from about 80° C. to about 200° C. to cure. Insufficient heat during cure will result in a network with incomplete polymerization, and, thus, reduced mechanical, chemical and heat resistance. Cure temperature should typically attain the glass transition temperature (Tg) of the fully cured network in order to achieve maximum properties. In an embodiment, the chemical matrix/hardener combination is cured at a temperature from about 80° C. to about 200° C. in an oven, and, more preferably, from about 85° C. to about 180° C., and, most preferably, from about 90° C. to about 165° C. In an embodiment, temperature may be increased in a step-wise fashion to control the rate of curing and prevent excessive heat build-up from the exothermic reaction. A suitable gas-fired oven is available from Wisconsin Oven. For example, the chemical matrix/hardener combination may be cured at a temperature from about 80° C. to about 100° C. for about four (4) hours, from about 110° C. to about 130° C. for about one (1) hour and from about 155° C. to about 175° C. for about four (4) hours. The optimum curing temperature(s) and curing rate(s) depend on the chemical composition.

In an embodiment, the chemical matrix curing reaction may be accelerated by addition of small quantities of an accelerator. Suitable accelerators include tertiary amines, carboxylic acids and alcohols (especially phenols). For example, Bisphenol A is widely used as an accelerator for epoxy resins.

In an embodiment, one or more other additives such as tougheners, fillers and/or pigments may be added to the chemical matrix. A suitable toughener (e.g., DuoMod) is available from Composites One; a suitable filler (e.g., silica) is available from Composites One; and a suitable pigment (e.g., black pigment) is available from Composites One. In an embodiment, the pigment is from about 0 to about 5 weight percent (wt %) of the total chemical matrix, more preferably, from about 0 to 3 wt %, and most preferably, from about 0 to 2 wt %.

In an embodiment, a removable mold may be secured around a plurality of layers of fibers. In an embodiment, the mold may be coated with a release agent. In an embodiment, the plurality of layers of fibers is infused with a chemical matrix under vacuum to remove the air.

In an embodiment, the method 400 further comprises a step 408 of milling or grinding the outer surface 134 of the composite tube 102 to refine the mandrel 100. A suitable milling machine is available from Cincinnati Milling Machine; and a suitable grinding machine is available from GCH Grinding Company. For example, FIG. 6 illustrates a photograph 600 of the step 408 of grinding an outer surface 134 of a composite tube 102 according to an embodiment of the present invention.

In an embodiment, a first section 110 of the composite tube 102 has a first outer diameter 112 and a second section 116 of the composite tube 102 has a second outer diameter 118. If the first outer diameter 112 and second outer diameter 118 are different, a shoulder 122 will be formed between the first section 110 and second section 116. In an embodiment, the first outer diameter 112 is from about 0.5 inch to about 12 inches, more preferably, from about 0.5 inch to about 10 inches, and, most preferably, from about 0.5 inch to about 8 inches. In an embodiment, the first outer diameter 112 is from about 0.5 inch to about 12 inches, more preferably, from about 0.5 inch to about 10 inches, and, most preferably, from about 0.5 inch to about 8 inches.

The method 400 further comprises a step 410 of removing the removable core. In an embodiment, the removable core may be extracted from the composite tube 102 or mandrel 100. In an embodiment, the removable core is a steel mold for supporting the interwoven fibers. The removable core may be pulled by a winch or pulley to remove the core. After pulling the core, the removable core may be used to make the next composite tube 102.

In an embodiment, the removable core may be milled to remove the core and to create an inner diameter 108 of the composite tube 102 or mandrel 100.

In an embodiment, the composite tube 102 or mandrel 100 has an inner diameter 108 extending from a first end 104 to a second end 106. In an embodiment, the inner diameter 108 is from about 0.3 inches to about 12 inches, more preferably, from about 0.3 inches to about 6 inches and, most preferably, from about 0.3 inches to about 3 inches.

In an embodiment, the method 400 further comprises a step (not shown) of milling a beveled surface 124 on a first end 104 of the composite tube 102 or mandrel 100. As discussed above, a suitable milling machine is available from Cincinnati Milling Machine. The beveled surface 124 is defined by a first angle 126 with an interior surface 128 of the composite tube 102 or mandrel 100. In an embodiment, the first angle 126 is from about 40 to about 80 degrees, preferably from about 50 to 70 degrees, even more preferably from about 55 to about 65 degrees, and most preferably from about 58 to about 62 degrees.

In an embodiment, the method 400 further comprises a step (not shown) of milling a tapered end 130 on the second end 106 of the composite tube 102 or mandrel 100. The tapered end 130 is defined by a second angle 132 with an exterior surface 134 of the composite tube 102 or mandrel 100. In an embodiment, the second angle 134 is from about 40 to about 80 degrees, preferably from about 50 to 70 degrees, even more preferably from about 55 to about 65 degrees, and, most preferably from about 60 to about 63 degrees.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

### DEFINITIONS

As used herein, the terms “a,” “an,” “the,” and “said” means one or more, unless the context dictates otherwise.

As used herein, the term “about” means the stated value plus or minus a margin of error or plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject. However, non-material elements that do not substantially change the nature of the invention, such as various buffers, differing salts, extra wash or precipitation steps, pH modifiers, and the like, may be included in the subject.

As used herein, the term “simultaneously” means occurring at the same time or about the same time, including concurrently.

### INCORPORATION BY REFERENCE

All patents and patent applications, articles, reports, and other documents cited herein are fully incorporated by reference to the extent they are not inconsistent with this invention.

What is claimed is:

1. A mandrel for an isolation tool comprising:
a composite tube having a first end and a second end,
wherein the composite tube has an inner diameter extending from the first end to the second end;
wherein a first section of the composite tube has a first outer diameter and a second section of the composite tube has a second outer diameter;
wherein the first end has a beveled surface defined by a first angle with an interior surface of the composite tube;
wherein the composite tube is made from a plurality of layers of fibers coated with a chemical matrix; and wherein a second layer of fibers overlaps a first layer of fibers with a first angle of fabrication from about 40 to about 85 degrees.

2. The mandrel of claim 1, wherein a third layer of fibers overlaps the second layer of fibers with a second angle of fabrication from about 40 to about 85 degrees.

3. The mandrel of claim 1, wherein the fibers are selected from the group consisting of fiberglass, carbon, Kevlar, basalt and mixtures thereof.

4. The mandrel of claim 3, wherein the fiberglass is selected from the group consisting of E-glass, S-glass, CR-glass and mixtures thereof.

5. The mandrel of claim 1, wherein the chemical matrix is selected from the group consisting of epoxy resins, polyester resins, vinyl ester resins and mixtures thereof.

6. The mandrel of claim 5, wherein the epoxy resins is selected from the group consisting of aliphatic epoxy resins, glycidylamine epoxy resins, phenolic epoxy resins and mixtures thereof.

7. The mandrel of claim 1, wherein the chemical matrix further comprises one or more additives, and wherein the one or more additives are selected from the group consisting of a catalyst, a hardener, an accelerator, a toughener, a filler and a pigment.

8. The mandrel of claim 1, wherein the first angle defining the bevel is from about 40 to about 80 degrees.

9. The mandrel of claim 1, wherein the second end has a tapered end defined by a second angle with an exterior surface of the composite tubing.

10. The mandrel of claim 9, wherein the second angle is from about 40 to about 80 degrees.

11. The mandrel of claim 1, wherein the inner diameter is from about 0.3 inch to about 12 inches.

12. The mandrel of claim 1, wherein the first and second outer diameters are from about 0.5 inch to about 12 inches.

13. The mandrel of claim 1, wherein the first and second thicknesses are from about 0.3 inch to about 5 inches.

14. A method of making the mandrel of claim 1 comprising the steps of:
interweaving a plurality of layers of fibers around a removable core, wherein a second layer of fibers overlaps a first layer of fibers with a first angle of fabrication from about 40 to about 85 degrees and wherein a third layer of fibers overlaps the second layer of fibers with a second angle of fabrication;
coating the plurality of layers of fibers with a chemical matrix to form a composite tube;
curing the composite tube at ambient temperature by reacting the chemical matrix with itself in the presence of a catalyst or by reacting the chemical matrix with a hardener in the presence of heat to form a mandrel;
milling or grinding the outer surface of the composite tube to refine the mandrel, wherein a first section of the composite tube has a first outer diameter and a second section of the composite tube has a second outer diameter; and
removing the removable core.

15. The method of claim 14, wherein heat is provided by placing the composite tube in an oven at temperatures from about 80° C. to about 200° C.

16. The method of claim 15, wherein heat is provided by placing the composite tube in an oven at a temperature from about 80° C. to about 100° C. for about four (4) hours, from about 110° C. to about 130° C. for about one (1) hour and from about 155° C. to about 175° C. for about four (4) hours.

17. The method of claim 14, further comprising the step of milling a beveled surface on a first end of the composite tube, wherein the beveled surface is defined by a first angle with an interior surface of the composite tube.

18. The method of claim 14, wherein the first angle is from about 40 to about 80 degrees.

19. The method of claim 14, further comprising the step of milling a tapered end on the second end of the composite tube, wherein the tapered end is defined by a second angle with an exterior surface of the composite tubing.

20. The method of claim 19, wherein the second angle is from about 40 to about 80 degrees.

21. The method of claim 14, wherein the fibers are selected from the group consisting of fiberglass, carbon, Kevlar, basalt and mixtures thereof.

22. The method of claim 21, wherein the fiberglass is selected from the group consisting of E-glass, S-glass, CR-glass and mixtures thereof.

23. The method of claim 14, wherein the chemical matrix is selected from the group consisting of epoxy resins, polyester resins, vinyl ester resins and mixtures thereof.

24. The method of claim 23, wherein the epoxy resins are selected from the group consisting of aliphatic epoxy resins, glycidylamine epoxy resins, phenolic epoxy resins and mixtures thereof.

25. The method of claim 14, wherein the chemical matrix further comprises one or more additives, and wherein the one or more additives are selected from the group consisting of a catalyst, a hardener, an accelerator, a toughener, a filler and a pigment.
